(19) United States
(12) Patent Application Publication
(10) Pub. No.: US 2013/0099999 A1
(43) Pub. Date: Apr. 25, 2013

(54) RADIOFREQUENCY CIRCUIT ASSEMBLY

(71) Applicant: Sarantel Limited, Wellingborough (GB)

(72) Inventor: Andrew Robert Christie, Mawsley (GB)

(73) Assignee: SARANTEL LIMITED, Wellingborough (GB)

(21) Appl. No.: 13/654,261

(22) Filed: Oct. 17, 2012

Related U.S. Application Data
(60) Provisional application No. 61/551,387, filed on Oct. 25, 2011.

(30) Foreign Application Priority Data
Oct. 20, 2011 (GB) 1118159.1

(51) Int. Cl. H01Q 1/38

(52) U.S. Cl. 343/895

(57) ABSTRACT

This disclosure relates to a radiofrequency circuit assembly and a dielectrically-loaded antenna for use in the assembly. The antenna comprises a solid electrically insulative core having a passage therethrough extending from a first core surface portion to a second, oppositely facing core surface portion, and a printed circuit feeder structure secured in the core passage and having exposed antenna mounting projections at opposite respective ends of the passage. The printed circuit board mounting the antenna has a cut-out dimensioned to accommodate the antenna core with the passage extending substantially parallel to the plane of the board. The antenna mounting projections at both ends of the passage engage respective edge portions of the said printed circuit board adjacent the cut-out so that the antenna core is supported by the printed circuit board between spaced-apart mounting locations adjacent the oppositely facing core surface portions.

### CROSS-REFERENCE TO RELATED APPLICATIONS

This application claims the benefit of U.S. Provisional Application No. 61/551,387, filed on Oct. 25, 2011, and entitled “RADIOFREQUENCY CIRCUIT ASSEMBLY”, and also claims priority to United Kingdom Patent Application 1118159.1, filed on Oct. 20, 2011, and entitled “RADIOFREQUENCY CIRCUIT ASSEMBLY”, both of which are hereby incorporated herein by reference.

### FIELD

This disclosure relates to a radiofrequency circuit assembly and a dielectrically-loaded antenna for use in the assembly, the assembly and the antenna being for operation at a frequency in excess of 200 MHz

### BACKGROUND

Dielectrically-loaded antennas are disclosed in, for instance, U.S. Pat. Nos. 5,854,608, 5,945,963, 5,859,621, 6,690,336, 7,439,934 and 7,903,044. Each of these antennas has at least one pair of diametrically opposed helical antenna elements which are plated on a substantially cylindrical electrically insulative core made of a high relative dielectric constant material such as barium titanate. The material of the core occupies the major part of the volume defined by the core outer surface. Extending through the core from one end face to an opposite end face is an axial bore or passage containing a feed. At one end of the bore conductors of the feed are coupled to respective antenna elements which have associated connection conductors plated on the respective end face adjacent the end of the passage. At the other end of the passage, one of the feed conductors is connected to a conductor which links the antenna elements and, in each of these examples, is in the form of a conductive sleeve encircling part of the core to form a balun. Each of the antenna elements terminates on a rim of the sleeve and each follows a respective helical path from its connection to the feed.

In the above-mentioned U.S. Pat. No. 7,439,934 and related U.S. patent application Ser. Nos. 12/661,296 filed 15 Mar. 2010, and U.S. Ser. No. 13/317,097 filed 7 Oct. 2011, the feed structure incorporates a laminate board oriented perpendicularly to a feed line in the passage so as to lie face-to-face on the end face of the core. This laminate board incorporates an impedance matching network to provide an impedance match between the characteristic impedance of the feed line and the radiation resistance presented by the antenna elements.

U.S. Published Application No. 2011/0221650 (application Ser. No. 13/014,962, filed 27 Jan. 2011) discloses dielectrically-loaded antennas with quasi-coaxial laminate board feed structures in the core passage, the perpendicular laminate board overlying the end face of the core having a slot which receives an end portion of the laminate board in the core passage. This U.S. patent application also discloses methods for connecting the antenna to a printed circuit board bearing associated radiofrequency circuitry, e.g. a radiofrequency front-end amplifier.

Another prior patent application involving the combination of a dielectrically-loaded antenna and printed circuit board is U.S. Published Application No. 2008/0136738 (application Ser. No. 11/998,471 filed 28 Nov. 2007).

The disclosure of each of the above patent applications and patents is incorporated in the present application by reference.

### SUMMARY

It is an object of embodiments of the disclosed technology to provide an improved antenna and printed circuit board combination.

According to a first aspect of the disclosed technology, a radiofrequency circuit assembly comprises the combination of a dielectrically-loaded antenna and a printed circuit board mounting the antenna, wherein: the antenna comprises a solid electrically insulative core of a material having a relative dielectric constant greater than 5, the core having a passage therethrough extending from a first core surface portion to a second, oppositely facing core surface portion, and a printed circuit feeder structure secured in the core passage and having exposed antenna mounting projections at opposite respective ends of the passage, at least one of the tabs bearing conductors for connecting the antenna to associated circuitry; the printed circuit board mounting the antenna has a cut-out dimensioned to accommodate the antenna core with the passage extending substantially parallel to the plane of the board; the antenna mounting projections at both ends of the passage engage respective edge portions of the said printed circuit board adjacent the cut-out so that the antenna core is supported by the printed circuit board between spaced-apart mounting locations adjacent the oppositely facing core surface portions, the board further comprising conductive areas at at least one of the mounting locations, electrically connecting the conductors of the feeder structure to circuitry on the board.

In one embodiment of the disclosed technology, the antenna is a backfire multifilar helical antenna for receiving and/or transmitting circularly polarised waves. In this case the core is cylindrical, having first and second oppositely directed core surface portions oriented perpendicularly to the axis of the cylinder, and a cylindrical side surface portion bearing radiating elements as plated helical conductors. The feeder structure comprises a printed circuit transmission line in the core passage coupled, at end of the passage, to the radiating elements and, at the opposite end of the passage, to conductive areas on the printed circuit board mounting the antenna. A matching network may be included as part of the feeder structure, typically located on a laminate board overlying the transverse core surface portion where the feeder structure is coupled to the helical antenna elements.

In the preferred embodiment, the feeder structure comprises two laminate board parts: a longitudinal laminate board part forming a transmission line which is housed in the core passage, and a lateral laminate board part extending laterally from the distal end of the core passage over the adjacent transversely oriented core surface portion. Conductors on the lateral laminate board part are electrically connected to conductors on this adjacent core surface portion so as to couple the antenna elements to the transmission line via, if present, the matching network.

In the case where the lateral laminate board part lies in a plane perpendicular to the core axis and is a laminate board component which is separately formed from that of the longitudinal laminate board part, the lateral laminate board part has a slot receiving a distal end portion of the longitudinal laminate board part. At least one conductor on the lateral laminate board part is electrically connected to a conductor on the longitudinal laminate board part at an edge of the slot.

In the preferred embodiment, the antenna mounting tabs include lateral outer extensions of the lateral laminate board part, which extensions project beyond the side surface portion of the antenna. At the other end of the passage, the longitudinal laminate board part projects beyond the respective end of the passage to form another mounting tab. Accordingly, with the longitudinal laminate board part fixed in the core passage, the core is effectively suspended between two spaced-apart mounting locations where the mounting tabs are secured to the printed circuit board mounting the antenna.

It is preferred that each of the antenna mounting tabs has a surface portion which is bonded to a major face of the printed circuit board mounting the antenna, these mounting tab surface portions being coplanar so that the connections to the printed circuit board are all made on one side of the latter. The connections between the mounting tabs and the printed circuit board are preferably solder joints, both mounting tabs and printed circuit board having plated conductive areas in registry with each other.

In the case of the lateral laminate board part comprising a laminate board oriented perpendicularly to the longitudinal laminate board part and to the axis of the core, the mounting tabs of the lateral laminate board part may comprise integral oppositely projecting fingers which have coplanar surface portions secured to the printed circuit board major face.

According to a second aspect of the disclosed technology, a dielectrically-loaded antenna has an operating frequency in excess of 200 MHz and comprises: an electrically insulative core of a solid material which has a relative dielectric greater than 5 and occupies the major part of the interior volume defined by the core outer surface, the core outer surface comprising oppositely directed distal and proximal outer surface portions, a side surface portion extending between the distal and proximal surface portions, and a passage extending through the core from the distal surface portion to the proximal surface portion; a three-dimensional antenna element structure disposed on or adjacent the side surface portion of the core; and a feeder structure comprising a longitudinal laminate board part housed in the core passage and a lateral laminate board part extending laterally from one end of the core passage over the distal surface portion of the core; wherein the feeder structure has exposed antenna mounting projections at opposite respective ends of the core passage, at least one of the projections having a conductive surface for connecting the antenna to associated circuitry; and wherein the mounting projections include distal mounting projections forming extensions of the lateral laminate board, which extensions project laterally in opposite directions beyond the said side surface portion of the core.

The printed circuit board mounting the antenna typically carries a receiver front end, which may include a low-noise amplifier or a complete receiver, for instance, a GPS receiver chip. In this way, the combination of the antenna and the printed circuit board mounting the antenna may constitute a rugged self-contained receiver module for mounting in a variety of devices. The printed circuit board may also include a transmitter for generating RF power signals to be fed to the antenna.

The disclosed technology will be described below by way of example with reference to the drawings.

### BRIEF DESCRIPTION OF THE DRAWINGS

In the drawings:

FIG. 1 is a perspective view of a radiofrequency circuit assembly in accordance with embodiments of the disclosed technology showing an antenna mounted in a cut-out in a printed circuit board, the antenna being viewed from below and to one side;

FIG. 2 is a perspective view of the assembly of FIG. 1, the antenna being viewed from above;

FIG. 3 is an exploded perspective view of the assembly, the antenna being viewed from above and to one side;

FIG. 4 is an exploded perspective view of the antenna forming part of the assembly shown in FIGS. 1 to 3, viewed from below and to one side; and

FIG. 5 is an exploded perspective view of a second assembly in accordance with embodiments of the disclosed technology, the antenna being viewed from above and to one side.

### DETAILED DESCRIPTION

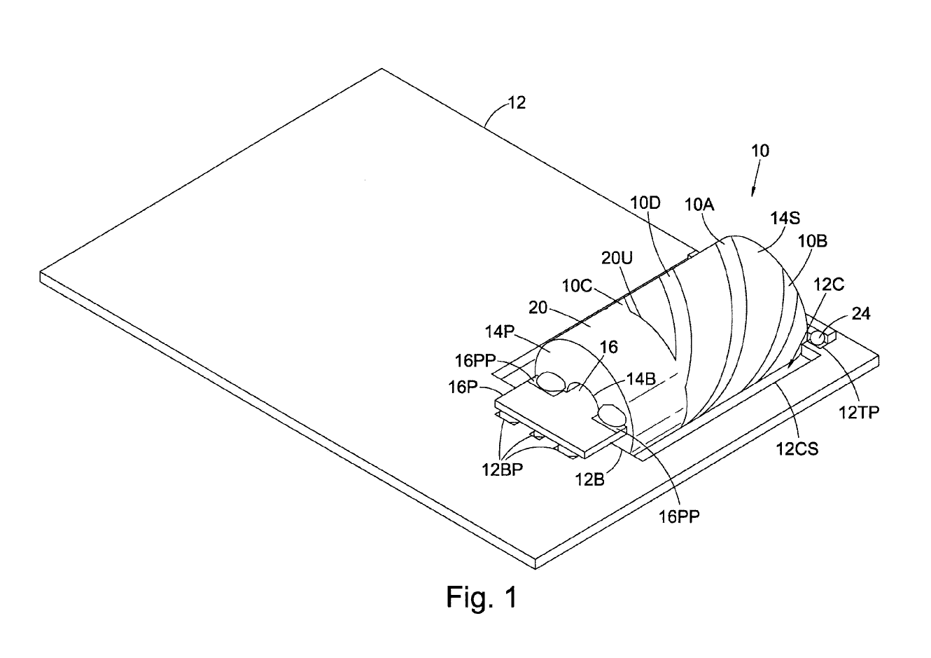

Referring to FIGS. 1 to 3, a radiofrequency circuit assembly in accordance with embodiments of the disclosed technology comprises a dielectrically-loaded antenna 10 and a printed circuit board 12 mounting the antenna. The antenna is a quadrifilar helical antenna having a cylindrical dielectric core and, plated on a cylindrical side surface portion 14S of the core, four axially coextensive plated helical antenna elements 10A-10D. This preferred antenna is a backfire helical antenna, in that it has a shielded feed housed in an axial bore 14B that passes through the core from a distal end outer surface portion 14D to an oppositely directed proximal end outer surface portion 14P of the core. Both end surface portions 14D, 14P are planar and perpendicular to the central axis of the cylindrical core. The feed is a multiple-layer longitudinally oriented laminate board 16 having an embedded inner conductor and, on opposite sides of the inner conductor, shield conductors formed by plated outer conductive layers which are connected to each other by a series of vias running along the edges of the longitudinal board so that the outer layers and the inner, embedded layer together form a quasi-coaxial transmission line. These features of the laminate board are not shown in the drawings, but are disclosed in the above-referenced US 2011/0221650. As also disclosed in US2011/0221650, the longitudinal laminate board has nibs projecting from each longitudinal edge to an extent such that the laminate board 16 is an interference fit in the bore 14B.

As best seen in FIG. 1, the longitudinal laminate board 16 has a proximal extension 16P extending beyond the proximal end surface portion 14P of the core. This extension 16P itself extends laterally beyond the diameter of the bore 14B and has an edge abutting the core proximal end surface portion 14P substantially along a diameter of the core.

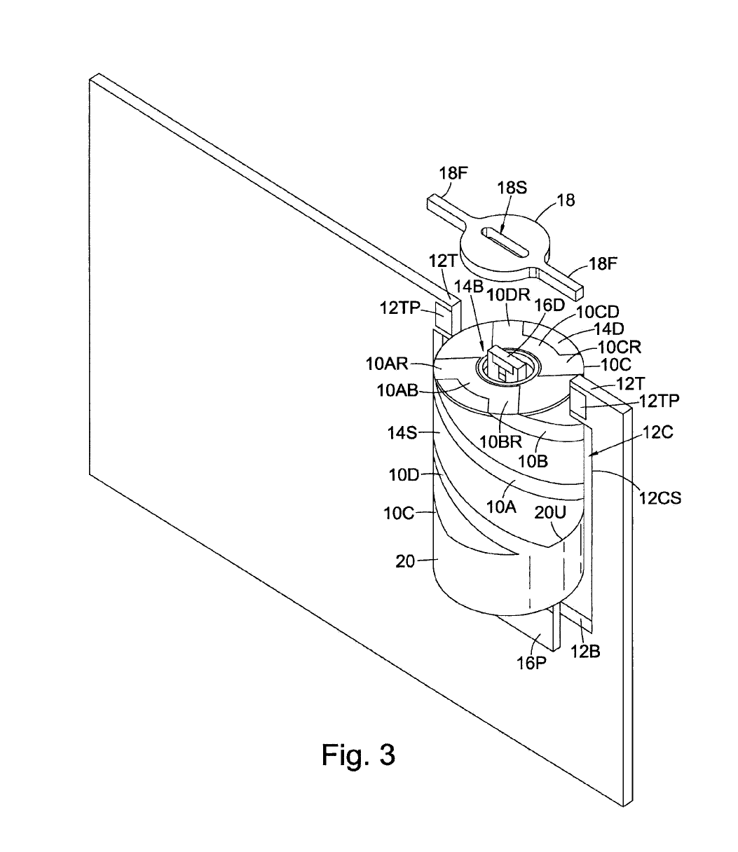

At the other end of the bore 14B, the longitudinal laminate board 16 has a distal end portion 16D (see FIG. 3) which projects beyond the distal outer surface portion 14D of the core.

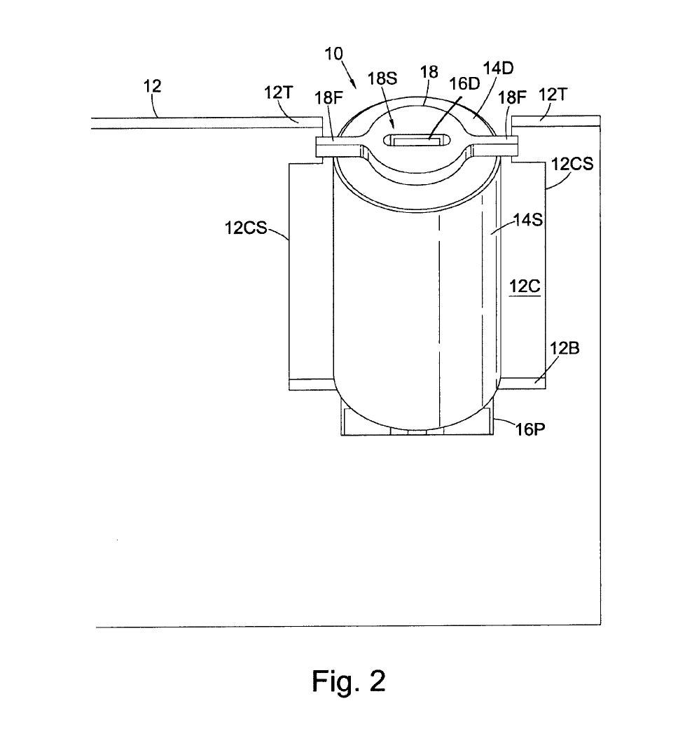

The longitudinal laminate board 16 forms part of a composite feed structure which also includes a lateral laminate board 18 which, in this embodiment, comprises a plated disc lying in face-to-face contact on the distal end surface portion 14D of the core, the plane of the board lying perpendicular to the core axis. As disclosed in US2011/0221650, the lateral laminate board 18 has a central slot 18S dimensioned to receive the distal end portion 16D of the longitudinal laminate board 16, as shown in FIG. 2.

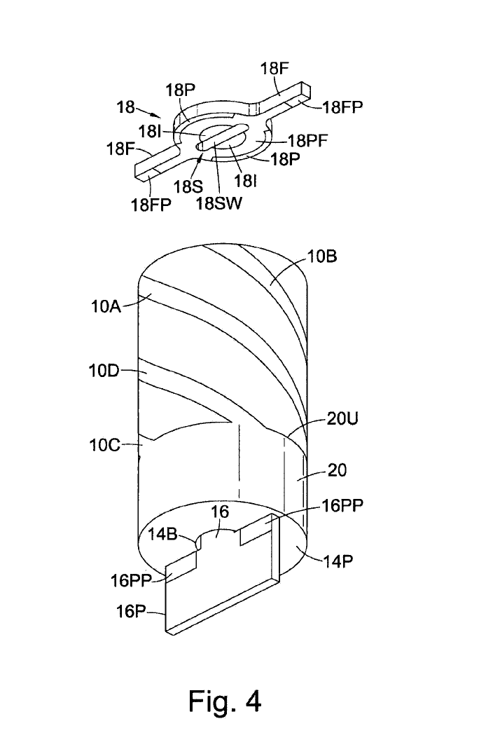

Referring to FIG. 4, the slot 18S in the lateral laminate board 18 has elongate side walls 18SW which are each plated (only one such plated wall 18SW is visible in FIG. 4), each plated side wall 18SW being connected to a respective segment-shaped inner plated area 181 on the proximal face 18PF of the laminate board 18. On each side of the slot, the lateral laminate board 18 has arcuate peripheral conductor areas 18P extending over the side edges of the board 18. Embodied in and/or carried by the lateral laminate board are circuit elements (not shown) interconnecting the conductors associated with the slot side walls 18SW and the peripheral conductor areas 18P. These circuit elements may constitute an impedance matching network of the kind disclosed in the above-mentioned U.S. Pat. No. 7,439,934.

Referring again to FIG. 3, the distal end surface portion 14D of the core carries four radial connection portions formed as radial tracks 10AR-10DR each associated with one of the helical elements 10A-10D. These radial connection tracks 10AR-10DR are connected in pairs 10AR, 10BR; 10CR, 10DR to arcuate conductors 10AB, 10CD plated on the core distal surface portion 14D adjacent the end of the bore 14B.

The orientation of the longitudinal laminate board 16 with respect to the conductive pattern on the core end face 14D, together with the dimensions of the lateral laminate board 18, are such that when the lateral laminate board 18 is fitted to the longitudinal laminate board 16 with the distal portion 16D of the latter housed in the slot 18S, the peripheral plated conductor areas 18P of the lateral laminate board 18 are in face-to-face contact with the arcuate conductors 10AB, 10CD on the core distal end face 14D.

The distal end portion 16D of the longitudinal laminate board 16 carries conductive connecting pads 16DP, only one of which is visible in FIG. 3, for contacting the plated side walls 18SW of the slot 18S.

Since, during manufacture of the antenna 10, solder paste is screen-printed on the proximally facing conductive areas 181, 18P of the lateral laminate board 18, subsequent heating of the assembled antenna components in a reflow oven causes the solder interconnection of the connecting pads 16DP on the distal end portion 16D of the longitudinal laminate board, as well as the arcuate conductors 10AB, 10CD on the core end face 14D, on the one hand, with the correspondingly located plated areas of the slot side walls 18SW and peripheral conductors 18P of the lateral laminate board 18 on the other hand. As a result, the antenna elements 10A-10D are coupled in pairs to the inner and outer conductors of the feed line and the lateral laminate board 18 is rigidly secured to the longitudinal laminate board 16 to form a unitary feed structure, and to the core.

At their proximal ends, the antenna elements 10A-10D are connected to a common virtual ground conductor 20 which is annular and in the form of a plated sleeve 20. The sleeve 20 is conductively continuous with a plated conductive covering of the proximal end surface portion 14P of the core. Conductive pads 16PP on the lateral extensions of the longitudinal laminate board part 16 (see FIGS. 1 and 4) extend to the distal edges of the latter and are connected to the outer shield conductors (not shown) of the transmission line formed by the longitudinal laminate board 16. During manufacture of the antenna, solder paste is applied to the conductive pads 16PP so that during reflow heating, the pads are electrically connected by solder fillet joints to the plates proximal end surface portion 14P of the core. The combination of the sleeve 20, the plating of the core proximal surface portion 14P and the shield conductors of the transmission line form a balun at the operating frequency of the antenna, the rim 20U of the conductive sleeve 20 acting as a resonant annular conductive path interconnecting the helical antenna elements 10A-10D. Further details of the antenna 10 and its operation are disclosed in the above-mentioned prior art publications. The quadrifilar helical antenna of the preferred embodiment has a cardioid-shaped, distally directed radiation pattern for circularly polarised waves and is, therefore, suited to reception and transmission of satellite communication signals, including the reception of global positioning system signals.

In accordance with embodiments of the disclosed technology, the above-described antenna 10 is mounted to a printed circuit board to form a radiofrequency circuit assembly. More particularly, the antenna 10 is mounted in a cut-out 12C of the printed circuit board, as shown in FIGS. 1 to 3, the cut-out 12C being dimensioned to accommodate the antenna with the axial bore 14B of the core lying generally in the plane of the printed circuit board 12. The cut-out or aperture 12C is rectangular, its side edges 12CS running parallel to the side surface portion 14S of the core. At least one side (the underside in FIG. 1) of the printed circuit board 12 is plated over the majority of its area to form a ground plane. In this instance, the ground plane extends to the cut-out side edges 12CS and the spacing of the aperture side edges 12CS from the radiating elements 10A-10D of the antenna is about 2.5 mm. In other embodiments, depending on the nature of the antenna and the intended function of the circuit assembly, the spacing may be less than or more than 2.5 mm, e.g. down to 1 mm, or, typically, up to 5 mm. It is not necessary for the ground plane of the printed circuit board 12 to extend fully to the edges 12CS of the aperture in the region of the antenna elements 10A-10D. Indeed, the ground plane may be spaced from the aperture edges 12CS, the restrictions on spacing from the antenna elements 10A-10D applying with respect to the edges of the ground plane rather than to the aperture edges in that case.

In the region of the conductive sleeve 20 and the proximal end surface portion 14P of the antenna core, the aperture periphery may be much closer to the antenna core since they are substantially non-radiating.

In this embodiment, the aperture 12C is open-ended in that it is open in the region of the distal end surface portion 14D of the core, although the aperture sides extend beyond the core distal end surface portion 14D. It follows that the ground plane of the printed circuit board 12 does not extend over the distal end of the antenna 10, i.e. leaving the part of the outer surface of the antenna facing the maximum of the radiation pattern clear of adjacent conductive material. Put another way, the conductive parts of the printed circuit board 12 do not extend over the distal face of the antenna.

As seen in FIGS. 2 and 3, each side wall 12CS of the cut-out or aperture 12C in the printed circuit board 12 is shaped so as to be closer to the antenna, i.e. closer to the antenna axis, where it is in registry with the distal end surface portion 14D of the core. Accordingly, the printed circuit board 12 has two tongues 12T adjacent the antenna distal end surface portion 14D. As shown in FIG. 3, each tongue 12T has a plated conductive pad 12TP. On the same face of the printed circuit board 12, there are plated conductive pads 12BP adjacent the base edge 12CB of the cut-out 12C, as seen in FIG. 1.

Referring to FIG. 4 in conjunction with FIGS. 1 to 3, on the antenna the lateral laminate board 18 of the feeder structure has mounting tabs in the form of radially extending integral fingers 18F which project laterally on opposite sides of the disc-shaped portion so as to project beyond the side surface portion 14S of the antenna core and so as to overlap the inwardly projecting tongues 12T of the printed circuit board 12. Each projecting finger carries a conductive area 18FP at its end, plated on the laminate board surface which faces the distal end surface portion 14D of the core. During manufacture of the assembly, solder paste is applied to the conductive pads 12TP on the printed circuit board tongues 12T so that when the assembly is passed through a reflow oven with the lateral laminate board fingers 18F abutting the printed circuit board tongues 12T, a solder fillet 24 (FIG. 1) is formed in the angle between the respective conductive pads at each mounting location formed by the juxtaposition of the board fingers 18F and the printed circuit tongues 12T.

On the underside of the proximal extension 16P of the antenna feed structure longitudinal laminate board 16 there are conductive areas (not shown in the drawings) located so as to be in registry with the conductive pads 12BP on the printed circuit board 12 adjacent the cut-out edge 12B. During manufacture of the assembly, solder paste is applied to the pads 12BP so that when the assembly is passed through the reflow oven with the longitudinal laminate board proximal extension 16P overlying the printed circuit board 12 adjacent the base edge 12B of the cut-out 12C, solder joints are formed between the pads 12BP on the board 12 and the conductive areas on the underside of the feed structure longitudinal laminate board extension 16P.

As a consequence of the projection of the proximal extension 16P of the feed structure longitudinal laminate board 16 and the laterally extending fingers 18F of the feeder structure lateral laminate board 18, and of their juxtaposition with portions of the printed circuit board 12 adjacent the cut-out 12C, they provide antenna mounting tabs at opposite respective ends of the core passage or bore 14B so that the antenna has longitudinally or axially spaced-apart mountings. The antenna core is, therefore, effectively suspended between spaced-apart mounting locations on the printed circuit board 12, providing mechanical robustness. The mounting tabs formed by the proximal laminate board extension 16P and the laterally projecting laminate board fingers 18F are, in this preferred embodiment, bonded to a major face of the printed circuit board 12 by conductive, i.e. solder, joints. The conductive joints between the longitudinal laminate board proximal extension 16P and the conductive pads 12BP on the upper face of the printed circuit board 12 constitute electrical connections between the antenna feed structure and circuitry (not shown) on the printed circuit board 12.

It is not necessary for the antenna mounting tabs formed by the proximal extension 16P and the lateral extensions 18F to be secured to the printed circuit board 12 by solder joints. Other fastening techniques may be used, including non-conductive bonding.

While, in the preferred embodiment, the surface portions of the mounting tabs formed by the proximal extension 16P and the lateral fingers 18F overlying the printed circuit board 12 are co-planar and bonded to a single planar surface of the board 12, alternative configurations are possible, including attachment to opposite sides of the printed circuit board mounting the antenna, or seating of the tabs or other projecting elements in recesses or notches in the board, to give just two examples.

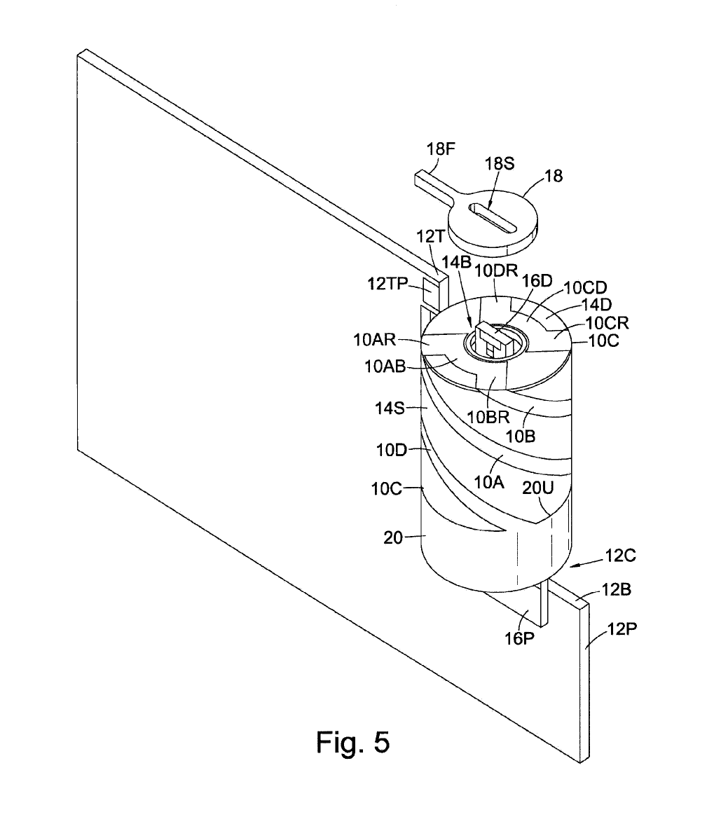

In a particular alternative embodiment, the cut-out 12C in the printed circuit board 12 mounting the antenna is a cut-out having only two sides, as shown in FIG. 5, being, effectively, a cut-out 12C taken from a corner of the board 12. The cut-out 12C has a single side edge 12CS and a base edge 12B. The periphery 12P of the printed circuit board 12 preferably extends laterally of the antenna axis at least as far as the outer cylindrical surface 14S of the antenna core, but the lateral extent of the board may be less than this, providing it is of sufficient lateral extent to receive the proximal mounting tab 16P in an overlapping relationship. In this embodiment, the lateral laminate board 18 of the antenna feed structure has a single laterally projecting finger 18F which, in the finished assembly, is secured to a single tongue 12T adjacent the antenna distal end surface portion 14D. The single finger 18F of the lateral laminate board 18 forms a distal mounting tab for the antenna 10, the core of the antenna being effectively suspended between the spaced-apart mounting locations of the projecting finger 18F and the proximal mounting tab 16P mounted on portions of the printed circuit board 12 adjacent the cut-out 12C.

The above-described assembly constitutes a robust self-contained module for incorporation in portable communication equipment in particular, such equipment including handheld devices with global positioning system receivers, in devices for two-way satellite communication, in tracking devices, and so on. Falling within the scope of the disclosed technology are assemblies including antennas other than quadrifilar helical antennas. For instance, antennas with cubiod-shaped dielectric cores may be used, as well as helical antennas with less than or more than four helical elements. Examples of such antennas for receiving and/or transmitting linearly polarised or circularly polarised waves for terrestrial or satellite systems are disclosed in the above-mentioned prior patent publications. The printed circuit board 12 may simply carry a low noise amplifier, a transmitter output stage, or filters but, advantageously, may include a complete integrated circuit receiver and other circuitry thereby maximising the integration of equipment circuitry with the antenna.

What is claimed is:

1. A radiofrequency circuit assembly comprising the combination of a dielectrically loaded antenna and a printed circuit board mounting the antenna, wherein:
the antenna comprises a solid electrically insulative core of a material having a relative dielectric constant greater than 5, the core having a passage therethrough extending from a first core surface portion to a second, oppositely facing core surface portion, and a printed circuit feeder structure secured in the core passage and having exposed antenna mounting projections at opposite respective ends of the passage, at least one of the projections bearing conductors for connecting the antenna to associated circuitry;
the printed circuit board mounting the antenna has a cut-out dimensioned to accommodate the antenna core with the passage extending substantially parallel to the plane of the board;
the antenna mounting projections at both ends of the passage engage respective edge portions of the said printed circuit board adjacent the cut-out so that the antenna core is supported by the printed circuit board between spaced-apart mounting locations adjacent the oppositely facing core surface portions, the board further comprising conductive areas at at least one of the mounting locations, electrically connecting the conductors of the feeder structure to circuitry on the board.

2. An assembly according to claim 1, wherein the antenna is a backfire helical antenna having a plurality of radiating antenna elements on a side surface portion of the core which extends between the said oppositely facing core surface portions, wherein the feeder structure comprises a printed circuit transmission line in the core passage coupled, at a distal end of the passage, to at least one of the antenna element and, at the opposite, proximal end of the passage, to the said conductive areas on the printed circuit board mounting the antenna.

3. An assembly according to claim 2, wherein the feeder structure comprises a longitudinal laminate board part forming the transmission line and housed in the core passage, and a lateral laminate board part extending laterally from the distal end of the core passage over the adjacent core surface portion, conductors on the lateral laminate board part being electrically connected to conductors on the said adjacent core surface portion to couple the antenna elements to the transmission line.

4. An assembly according to claim 3, wherein the lateral laminate board part comprises a laminate board oriented perpendicularly to the longitudinal laminate board part and lying face-to-face on the said core surface portion which is adjacent the distal end of the passage.

5. An assembly according to claim 4, wherein the lateral laminate board part has a slot receiving a distal end portion of the longitudinal laminate board part, at least one conductor on the lateral laminate board part being electrically connected to a conductor on the longitudinal laminate board part at an edge of the slot.

6. An assembly according to claim 4, wherein the antenna mounting projections include lateral outer extensions of the lateral laminate board part projecting beyond the side surface portion of the antenna.

7. An assembly according to claim 1, wherein each of the antenna mounting projections comprises a mounting tab which has a surface portion which is bonded to a major face of the printed circuit board mounting the antenna, the said mounting tab surface portions being coplanar.

8. An assembly according to claim 2, including an impedance matching network forming part of the feeder structure.

9. An assembly according to claim 1, wherein each of the mounting projections is bonded to the printed circuit board mounting the antenna by a solder joint.

10. An assembly according to claim 1, wherein the feeder structure comprises a longitudinal laminate board part housed in the core passage and a lateral laminate board part extending laterally from one end of the core passage over the adjacent core surface portion on opposite sides of the passage, and wherein the lateral laminate board part has antenna mounting tabs projecting laterally beyond the core in opposite respective directions.

11. An assembly according to claim 10, wherein the lateral laminate board part comprises a laminate board oriented perpendicularly to the longitudinal laminate board part and the mounting tabs of the lateral board part comprises oppositely projecting fingers having coplanar surface portions bonded to a major face of the printed circuit board mounting the antenna.

12. A dielectrically loaded antenna having an operating frequency in excess of 200 MHz, comprising:
an electrically insulative core of a solid material which has a relative dielectric greater than 5 and occupies the major part of the interior volume defined by the core outer surface, the core outer surface comprising oppositely directed distal and proximal outer surface portions, a side surface portion extending between the distal and proximal surface portions, and a passage extending through the core from the distal surface portion to the proximal surface portion;
a three-dimensional antenna element structure disposed on or adjacent the side surface portion of the core; and
a feeder structure comprising a longitudinal laminate board part housed in the core passage and a lateral laminate board part extending laterally from one end of the core passage over the distal surface portion of the core;
wherein the feeder structure has exposed antenna mounting projections at opposite respective ends of the core passage, at least one of the projections having a conductive surface for connecting the antenna to associated circuitry; and
wherein the mounting projections include distal mounting projections forming extensions of the lateral laminate board, which extensions project laterally in opposite directions beyond the said side surface portion of the core.

13. An antenna according to claim 12, wherein the mounting tabs have respective coplanar mounting surface portions.

14. An antenna according to claim 12, wherein the laminate board part comprises a laminate board oriented perpendicularly to the longitudinal laminate board part and the mounting projections of the lateral board part comprise oppositely projecting fingers.

15. An antenna according to claim 13, wherein the coplanar surface portions of the mounting tabs each have an associated conductor allowing the tabs to be bonded to a common planar printed circuit board by solder joints.
